(19) United States
(12) Patent Application Publication
(10) Pub. No.: US 2004/0111355 A1
(43) Pub. Date: Jun. 10, 2004

(54) Systems and methods for tracking price information in an online credit derivative trading system

(75) Inventors: Sunil G. Hirani, Bedford, NY (US); Mazyar M. Dar, Stamford, CT (US)

Correspondence Address: PAUL, HASTINGS, JANOFSKY & WALKER LLP, P.O. BOX 919092, SAN DIEGO, CA, 92191-9092, US

(73) Assignee: Creditex, Inc.

(21) Appl. No.: 10/336,651

(22) Filed: Jan. 3, 2003

Related U.S. Application Data
(63) Continuation-in-part of application No. 10/316,167, filed on Dec. 9, 2002.

(51) Int. Cl. G06F 17/60

(52) U.S. Cl. 705/37; 705/36

(57) ABSTRACT

A credit derivative trading system comprises a credit derivative authority configured to receive defined positions for credit derivatives and update a plurality of trader clients in real-time whenever there is movement in the market for a particular credit derivative. The credit derivative trading system also allows trader clients to define, and receive credit derivative information for specified reference entities and to create portfolios of reference entities for which credit derivative information is displayed and tracked on a portfolio basis.

### RELATED APPLICATIONS INFORMATION

This application claims priority under 35 U.S.C. §120 as a Continuation in Part of U.S. patent application Ser. No. 10/316,167 (Attorney Dkt. No. 029121.0016.UTL1) entitled “Systems and Methods for an online credit derivative trading system,” filed Dec. 9, 2002, which is incorporated herein by reference in its entirety as if set forth in full.

### BACKGROUND

1. Field of the Inventions

The field of the invention relates generally to credit derivatives and more particularly to the transacting in credit derivatives in an online environment.

2. Background Information

Currently, conventional credit derivative markets comprise a user base of larger institutions. These large institutions use the credit derivative markets for a variety of reasons. For example, commercial banks, both domestic and foreign, can obtain significant economic, regulatory, and capital relief from selling credit risk in a credit derivative market. Commercial banks can also use the credit derivative markets to add credit risk to their portfolios as an alternative to the lending market. Insurers, which typically posses excellent credit evaluation skills, primarily use the credit derivative markets to take on credit risk for a premium. Investment management companies and Hedge Funds, or other investors, use the credit derivative markets to both take on and shed risk.

The dealer community represents some of the largest financial intermediaries in the world. The dealers tend to be large, multi-national institutions that make markets in credit derivatives. The scale and scope of each dealer's credit derivative business varies widely, with some dealers having extensive credit derivative operations, and other being occasional market participants. Thus, in conventional credit derivative markets, information flow is concentrated in a few dealers. Generally, the end users, such as those described above, transact through the dealers and not directly with each other. Often, information is scarce and incomplete as it relates to the buyers and dealers participating in the market, as is information concerning price and the risk associated with particular derivatives.

Dealers transact with other dealers via a broker market. A broker is an intermediary that transacts business between dealers. The brokers do not principal risk. Generally, information dissemination from the brokers is very inefficient. Further, the brokers business is limited to the dealers, because there is no meaningful contact between the brokers and end users.

There are other drawbacks to conventional credit derivative markets. One such draw back is that conventional credit derivative markets tend to be regionalized, e.g., with individual markets being localized by continent and/or time zones. For example, the U.S. credit derivative market tends to trade strictly in U.S. credit risk, while the European credit derivative market usually trades in European credit risk. Due to the manual and labor intensive nature of conventional credit derivative markets, it is very difficult for dealers to break down the localized nature of conventional credit derivative markets.

Another drawback is the high cost to transact in a conventional credit derivative market. Each dealer in a conventional credit derivative market tends to employ large intermediary infrastructure to facilitate the transactions. The size of the infrastructure leads to large transaction costs, which will remain as long as conventional credit derivative markets remain regionalized and controlled by just a few dealers. Further, because information is concentrated in the hands of a few large participants, conventional credit derivative markets are inefficient and illiquid. The illiquidity persists because for many of the largest participants, their only transactional outlet is through the dealers. Traditionally, another drawback is operational inefficiency that results from a lack of standardized documentation. The operational inefficiency is made worse by the fact that the documentation processes involved tend to be manual processes, which is also in part due top the lack of standardization.

One final drawback that will be mentioned here is the inefficient, fragmented, and disjointed distribution mechanisms of conventional credit derivative markets. When a market participant wants to transact, they will call one of a few dealers to ask for a price. Dealers usually will go through a broker at this point. Alternatively, the dealer will often call a limited number of other possible participants to determine if they are willing to transact. If the dealer determines that they are likely to find a willing participant at an acceptable spread, then the dealer will likely try to consummate the transaction, e.g.., using a broker. Frequently, however, multiple dealers are calling the same potential participants trying to determine a willingness to transact. As a result, potential transactions are often selected out of the market because participants have few outlets, the dealer feels that the fee to consummate the transaction is too low, and/or the dealer will not principal the risk because they fear they will not be able to find a willing participant on the other side of the transaction. Consequently, while a few participants benefit from the economic inefficiencies of conventional credit derivative markets, many do not.

### SUMMARY OF THE INVENTION

A credit derivative trading system comprises a credit derivative authority configured to receive defined positions for credit derivatives and update a plurality of trade clients in real-time whenever there is movement in the market for a particular credit derivative.

In another aspect of the invention, the credit derivative trading system comprises a standardized interface that allows trade clients to view information on credit derivatives in a compact and uniform format. The standardized interface also allows the trader clients to interface with the credit derivative authority in quick and efficient manner.

These and other features, aspects, and embodiments of the invention are described below in the section entitled “Detailed Description of the Preferred Embodiments.”

### BRIEF DESCRIPTION OF THE DRAWINGS

Features, aspects, and embodiments of the inventions are described in conjunction with the attached drawings, in which:

FIG. 1 is a diagram illustrating an example credit derivative trading system in accordance with one embodiment of the invention;

FIG. 2 is a flow chart illustrating an example method for transacting in a credit derivative in the system of FIG. 1 in accordance with one embodiment of the invention;

FIG. 3 is a flow chart illustrating an example method of receiving a responsive position within the system of FIG. 1 in accordance with one embodiment of the invention;

FIG. 4 is a flow chart illustrating an example method of receiving an indication of a willingness to transact within the system of FIG. 1 in accordance with one embodiment of the invention;

FIG. 5 is a screen shot illustrating a display of credit derivative information within on a terminal included in the system of FIG. 1 in accordance with one embodiment of the invention;

FIG. 6 is a screen shot illustrating the display of historical credit derivative information on a terminal included in the system of FIG. 1 in accordance with one embodiment of the invention;

FIG. 7 is a logical block diagram illustrating an exemplary computer system that can be included in the system of FIG. 1;

FIG. 8 is a flow chart illustrating an example method whereby a trader client can select reference entities for which they would like to receive credit derivative information in accordance with one embodiment of the invention;

FIG. 9 is a flow chart illustrating a method whereby a trader client can provide portfolio criteria to create a portfolio in accordance with one embodiment;

FIG. 10 is a screen shot illustrating an example display that is displayed on a trader client terminal included in the system of FIG. 1 and allows a trader client to input search criteria and view credit derivative information in accordance with one embodiment of the invention;

FIG. 11 is a screen shot illustrating an example display that is displayed on a trader client terminal included in the system of FIG. 1 and that provides a trader client with portfolio optimization information in accordance with one embodiment of the invention;

FIG. 12 is a screen shot illustrating a display that is displayed on a trader client terminal included in the system of FIG. 1 and that allows the trader client to navigate through a plurality of portfolios in accordance with one embodiment of the invention; and

FIG. 13 is a screen shot illustrating an example display that is displayed on a trader client terminal included in the system of FIG. 1 and that allows a trader client to navigate through, and select, available reports in accordance with one embodiment of the invention.

### DETAILED DESCRIPTION OF THE PREFERRED EMBODIMENTS

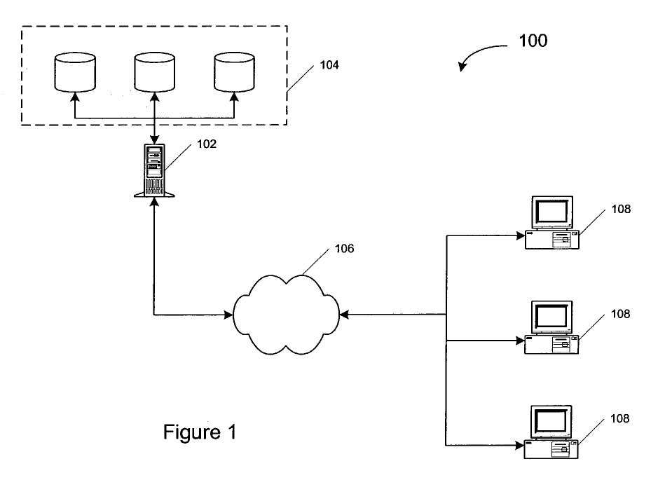

FIG. 1 is a diagram illustrating an example credit derivative trading system 100 in accordance with one embodiment of the systems and methods described herein. System 100 comprises a credit derivative authority 102 interfaced with a database 104. Database 104 can, as illustrated, actually comprise a plurality of databases depending on the embodiment. Credit derivative authority 102 is interfaced with a plurality of trader clients via terminals 108 through network 106.

In one embodiment, network 106 is the Internet; however, network 106 can be any type of wired or wireless Wide Area Network, wired or wireless Local Area Network, or even a wired or wireless Personal Area Network, or some combination thereof. Further, in certain credit derivative authority 102 and/or terminals 108 care interfaced with network 106 via wired and/or wireless communication links, while in another embodiment, credit derivative authority 102 and/or terminals 108 are interfaced with network 106 via wired communication links.

In one embodiment, terminals 108 are computer terminals, such as desktop or laptop computers. In other embodiments, terminals 108 are handheld devices, such as handheld computers or personal digital assistants. It will be apparent, however, that terminals 108 can be any type of terminal configured to include the functionality required by the systems and methods described herein.

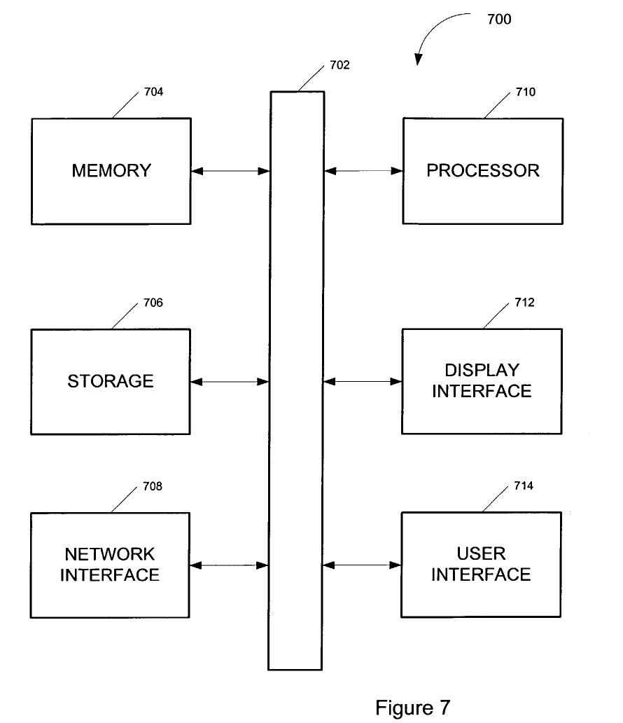

The term “authority” used to identify credit derivative authority 102 is intended to indicate that terminals 108 communicate with credit derivative authority 102 through the computing systems, hardware and software, associated with credit derivative authority 102. Thus, depending on the embodiment the term authority can refer to one or more servers, such as Internet or web servers, file servers, and/or database servers, one or more routers, one or more databases, one or more software applications, one or more Application Program Interfaces (APIs), or some combination thereof. Further, the computing system associated with credit derivative authority 102 can include one or more computers or computer terminals. To that extent, some of the same components that comprise the computer system associated with credit derivative authority 102 can also comprise terminals 108. An exemplary embodiment of a computer system that can comprise credit derivative authority 102 is described in more detail with respect to FIG. 7.

System 100 includes a standardize interface that allows the trader clients to define positions with credit derivative authority 102 for any of a plurality of credit derivatives regardless of the region, industry, etc. Credit derivative authority 102 is configured to then store the positions in database 104. Using the standardized interface, credit derivative authority 102 displays information related to the positions stored in database 104 to the trader clients via terminals 108. The trader clients are then able to define responsive positions, indicate a willingness to transact, and/or complete a transaction using the standardized interface. Thus, credit derivative authority 102 can replace the dealer-broker paradigm of conventional credit derivative markets and provides the trader clients with more outlets, greater liquidity, and more efficiency, all of which can help to lower transactional costs.

The standardized interface can comprise software components configured to run on credit derivative authority 102 as well as client software components configured to run on terminals 108. Thus, credit derivative authority 102 can work in conjunction with the client software running on terminals 108 to format and display information to the trader clients in a uniform manner and to receive input from the trader clients through terminals 108 in a manner that allows quick, easy, and efficient transactions. Certain features and aspects of the standardized interface are discussed more fully below.

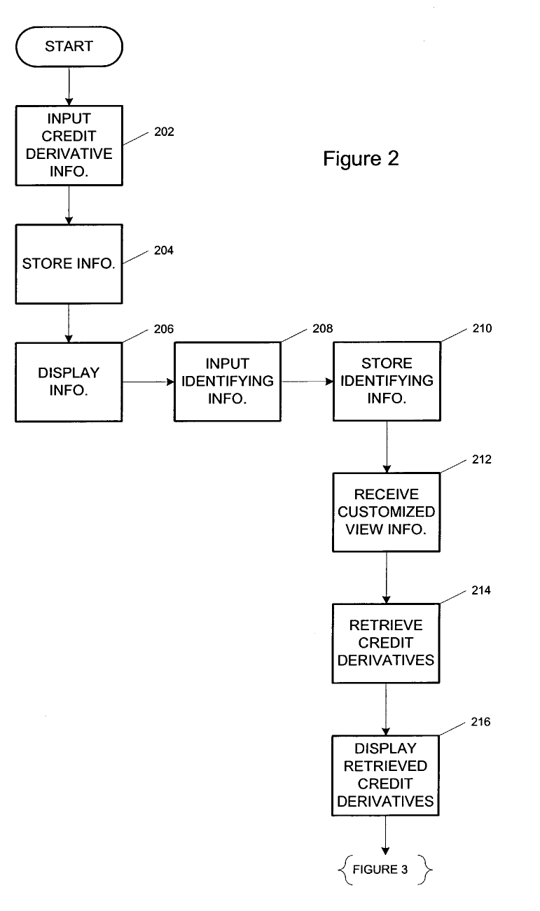

FIG. 2 is a flow chart illustrating an example method of transacting in credit derivatives using system 100 in accordance with the systems and methods described herein. First, in step 202, credit derivative authority 102 receives information related to a reference entity's credit risk that is available for transaction. In other words, when a trader client wants to move credit risk in a certain reference entity, the trader client can access credit derivative authority 102 and make the information available along with an ask price.

In step 204, credit derivative authority saves the information in database 104 and in step 206, credit derivative authority 102 causes the information to be displayed to the rest of the plurality of trader clients via their terminals 108. Because the trader clients can access credit derivative authority 102 from anywhere in the world, the credit derivatives made available by credit derivative authority 102 are not limited by region or industry. Thus, the previously fragmented nature of credit derivative markets can be addressed. Moreover, credit derivative authority 102 is preferably configured to cause the information to be displayed in a compact and uniform manner to all of the trader clients regardless of the type of credit derivative. Moreover, credit derivative authority is preferably configured to update trader clients in real-time as new credit derivatives are defined within system 100.

As an example of the compact and uniform display of information, credit derivative authority 102 is configured in certain embodiments, to display the following for each credit derivative defined in system 100: a reference entity name, scheduled termination of the credit derivative, a debt level, a bid price, an ask price, and a restructuring level. In other embodiments, credit derivative authority can also be configured to display the associated currency, a debt rating, and a debt type for each of the positions defined in system 100. Credit derivative authority 102 is configured, for example, to display the information using the standardized interface described above. Thus, credit derivative authority 102 retrieves the relevant information from database 104 and transmits it to a client application, or applications, running on terminals 108. The client applications then display the information in accordance with the systems and methods described herein.

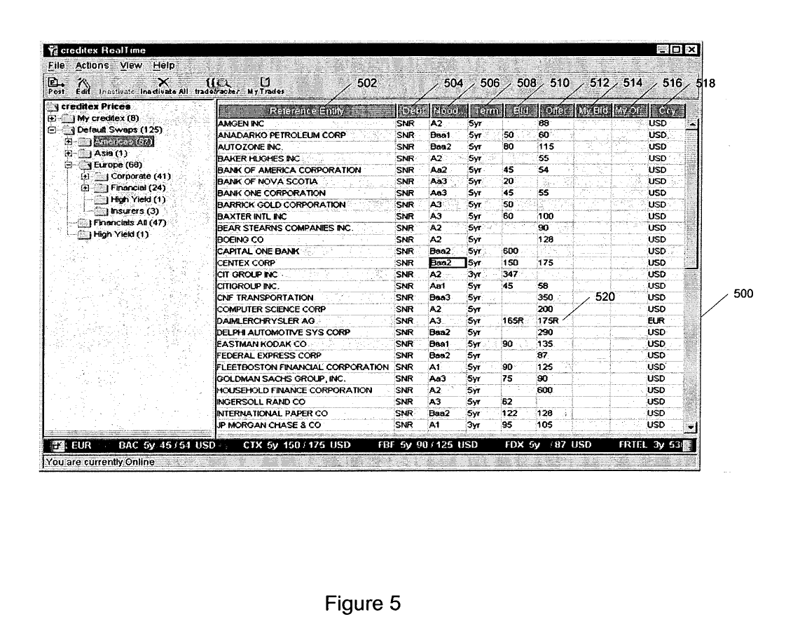

FIG. 5 is a screen shot illustrating an example method of displaying the information on terminals 108 using a compact and uniform format. Thus, the display screen 500 includes a plurality of columns 502-518. As can be seen, column 502 comprises the names of various reference entities for which credit derivatives have been made available in system 100. Column 504 comprises the debt type associated with each reference entity in column 502. Column 506 comprises a debt rating associated with each reference entity in column 502. Although, as mentioned above, this column may or may not be included depending on the embodiment. Column 508 comprises the scheduled termination associated with the credit derivative for the reference entity in column 502. Column 512 includes the associated ask prices, while column 510 includes responsive bids. Thus, once bids are received, the information can be displayed in column 510. Columns 514 and 516, included in certain embodiments, comprise the bid and or ask prices associated with the particular trader client on whose terminal 108 display 500 is being displayed. Finally, column 518 comprises the associated currency.

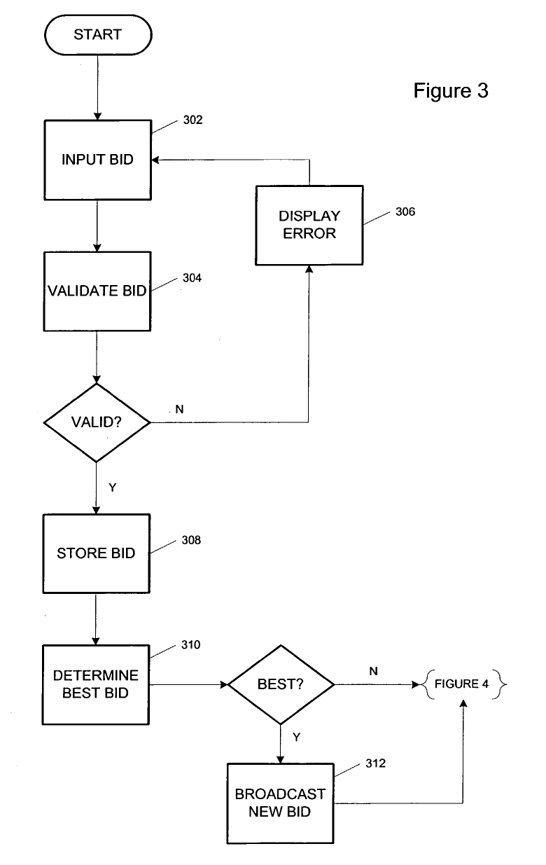

Once the information for a new credit derivative displayed in step 206, then bids can start to be received by credit derivative authority 102. This process is described below in relation to FIG. 3. Since the credit derivative market is a bilateral market, however, certain trader clients may not wish to deal with certain other trader clients in all, or certain, situations. Thus, in certain embodiments, credit derivative authority 102 is configured to receive information identifying trader clients with whom the trader client defining the new position is willing to transact, i.e., the trader client uses the standardized interface to provide identifying information to credit derivative authority 102 that identifies other trader clients with whom the trader client is willing to transact. Depending on the embodiment, the information includes the names of certain trader clients or defining characteristics of acceptable trader clients. Credit derivative authority 102 stores the identifying information in database 104 in step 210. The information is then used, as described below, in certain embodiments, by credit derivative authority 102 to help facilitate transaction between trader clients.

In certain embodiments, the trader clients can customize their view of the information displayed. Thus, for example, in step 212 credit derivative authority 102 receives, from a trader client, information defining the customized view requirements of a trader client, i.e., using the standardized interface, a trader client inputs information defining a customized view. For example, in one embodiment, a trader client specifies certain regions of interest in step 212. Then, in step 214, credit derivative authority 102 retrieves from database 104 credit derivatives only for the indicated regions. These credit derivatives are then displayed, in step 216, on the trader client's terminal 108. Alternatively, a trader client can customize the trader client's view by specifying, in step 212, certain industries, certain reference entity names, certain credit duration, certain debt levels, certain spreads, i.e., the difference between the ask and bid prices, certain restructuring levels, etc., that the trader client is interested in. In step 214 credit derivative authority 102 retrieves information for credit derivatives that meet the criteria input by the trader client.

In a process similar to view customization, trader clients can also preferably indicate certain alternative views that they are interested in. For example, in one embodiment, instead of indicating factors that define credit derivatives of interest, the trader client indicates, in step 212, an interest in certain historical information. Examples of historical information indicated in step 212 include, the historical spread information for a certain credit derivative, historical trades for the trader client, and historical transactions for a certain credit derivative. In certain embodiments, a relevant time period of interest is also indicated in step 212. Historical information conforming to the input criteria is then retrieved in step 214 and displayed in step 216.

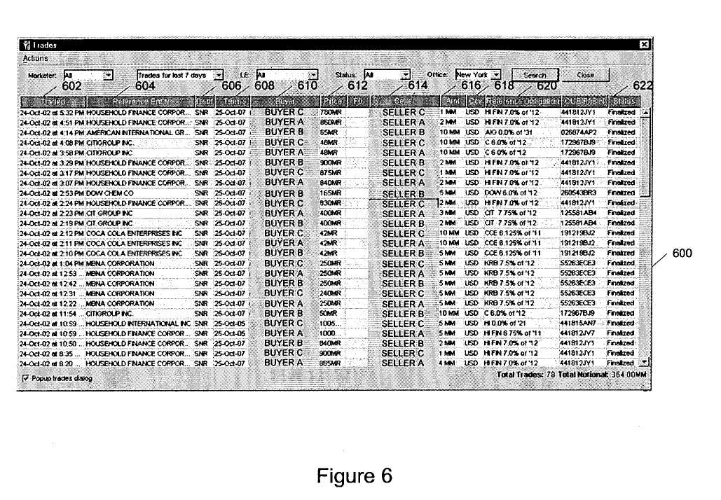

For example, FIG. 6 is a screen shot illustrating a display 600 of historical transactions for a certain credit derivatives. As can be seen, display 600 includes columns 602-614. Column 602 comprises the date of the associated transaction, column 604 comprises the name of the reference entity involved, column 606 comprises the type of debt, column 608 comprises the scheduled termination of the credit derivative, column 610 comprises the identity of the buyer, column 612 comprises the price, column 614 comprises the name of the seller, column 616 comprises the notional amount of the transaction, column 618 comprises the associated currency, column 620 comprise the reference obligation, and column 622 comprise the status of the transaction. Of course, depending on the embodiment, some of the columns illustrated in FIG. 6 are not included in display 600.

FIG. 3 is a flow chart illustrating an example process by which a responsive position is received and handled in real-time by system 100. The example processes of FIG. 3 assume that the original position defined was an ask and, therefore, the responsive position is a bid. But the process is largely the same for the reverse situation as well.

The process begins in step 302, when a trader client inputs a bid, e.g., through their standardized interface, in response to a recent ask. In step 304, credit derivative authority 102 validates the bid, e.g., checks to ensure that the bid specifies a valid credit derivative. If the bid is not valid, then credit derivative authority 102 causes an error message to be displayed on the trader client's terminal 108 and allows the trader client to input another bid (step 302). If the bid is valid, then credit derivative authority 102 stores, in step 308, the bid information.

In one embodiment, credit creative authority 102 then checks the bid against information stored in database 104 to determine if the bid is the best bid. In other words, credit derivative authority 102 checks bid information stored in database 104 to determine if the bid is the highest bid for the associated credit derivative. If the bid is the best bid, then in step 312, credit derivative authority 102 updates all the trader clients with the new bid information. The update that occurs in step 312 is essentially in real-time. Thus, the trader clients are receiving updated information as the credit derivative market moves. Conversely, if the position defined in step 302 is an ask, then credit derivative authority 102 determines, in step 310, whether the ask is lower than the previous ask and updates the trader clients, in step 312, when it is determined that the ask is the lowest ask.

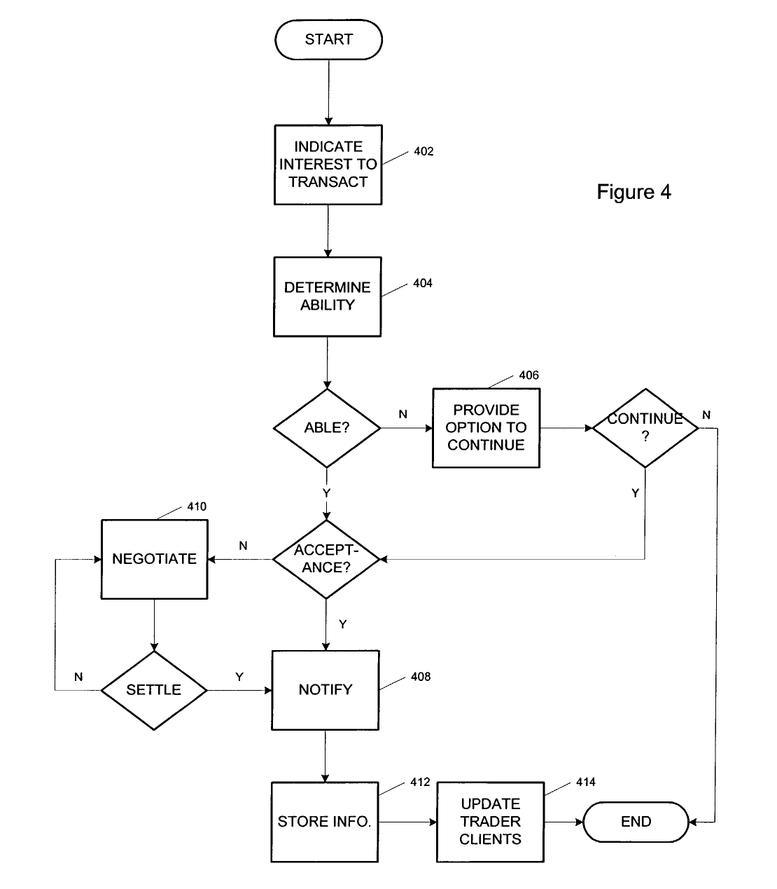

FIG. 4 is a flow chart illustrating an example process for engaging in a transaction within system 100. The process begins in step 402 with a trader client indicating a desire to transact in response to a received updated position (step 312). For example, the trader client uses their standardized interface to indicate a desire to transact. In one embodiment, when credit derivative authority 102 receives the indication, it determines the ability of the trader client to transact on the associated credit derivative. This is where the information provided in step 208 can come into play. Thus, in step 404, credit derivative authority 102 determines, based on information stored in database 104, whether the trader client indicating a desire to transact is acceptable to the other party.

In one embodiment, if credit derivative authority determines that the trader client is not acceptable, then in step 406 credit derivative authority 102 presents the other party with the option to proceed. If the other party declines, then the transaction is not consummated. If, on the other hand, the other party is willing to continue, or if it is determined in step 404 that the trader client is able to transact, then the transaction proceeds.

The trader client can indicate a willingness to transact in step 402, by indicating a willingness to accept the terms associated with the new position or by indicating a willingness to negotiate with the other party. If the indication in step 402 is an acceptance, then the other party is notified of the acceptance in step 408 by credit derivative authority 102. If the indication of step 402 is of a willingness to negotiate, then the parties negotiate with each other in step 410. As will be described in more detail below, the parties can negotiate aided by the standardized interface and credit derivative authority 102. In an alternative embodiment, once the trader client indicates a willingness to transact in step 402, they call, or are contacted by, a broker associated with credit derivative authority 102 to negotiate and settle the transaction.

Once the transaction settles, all of the information associated with the transaction is stored by credit derivative authority 102 into database 104 in real-time, i.e., the information is stored as it passes back and forth between the parties and between the parties and credit derivative authority 102. Credit derivative authority 102 then updates the information displayed to the trader clients, again in real-time, in step 414, based on the transaction information.

As mentioned above, system 100 comprises a standardized interface configured to make transacting in system 100 quick and efficient. Thus, the standardized interface allows each of the trader clients to interface with credit derivative authority 102 and view information on a plurality of credit derivatives that is displayed in a compact and uniform format. Example formats were described above, e.g., in relation to FIG. 5. As was also described, the standardized interface allows each of the trader clients to customize the trader client's view of the information displayed for the plurality of credit derivatives. This was explained, e.g., in relation to FIG. 6. Thus, the display of information can be customized using the standardized interfaced based any of the following: region, industry, a reference entity name, a credit duration, a debt level, a spread, a restructuring level, an ask price, and a credit rating.

The standardized interface is further configured to allow each of trader clients to define credit derivative positions online and to update them quickly and efficiently. For example, in one embodiment, a trader client simply inputs the information that defines the credit derivative and their position, e.g., bid or ask price, and then updates the position with credit derivative authority 102 with a single “click”. The term “click” is intended to indicate that the user simply needs to use an input device, such as a mouse, to select text, a button, or an icon. Moreover, the trader can use this simple process to update a position anytime, and all of the other trader clients will be updated automatically in real-time.

The standardized interface, in certain embodiments, is also configured to allow the trader clients to, at anytime, render inactive all or some of the trader clients defined positions with a single click. Trader clients can also reactivate some or all of their inactive positions using a single click, whenever they decide to do so. The other trader clients are then automatically updated, based on the deactivation and reactivation of positions, in real-time.

In certain embodiments, credit derivative authority 102 is configured to facilitate communication with trader clients via their terminals 108. This communication can be between trader clients, i.e., between terminals 108, and/or between trader clients and credit derivative authority 102, i.e., between terminals 108 and credit derivative authority 102. Thus, the standardized interface includes an electronic messaging tool, such as email or instant messaging. The trade clients input and send messages using the electronic messaging tool. The messages are received by credit derivative authority 102 and forwarded to the correct terminal 108, when required. The messaging capability is used for example, to facilitate negotiations and/or settlement of transactions between trader clients. Thus, in some instances the messages are between terminals 108 and include negotiation information. In other instances, the messages are between credit derivative authority 102 and a terminal 108 and include settlement information.

FIG. 7 is a logical block diagram illustrating an example embodiment of a computer system 700 that is, for example, included in the computer system that comprises credit derivative authority 102. As will be understood, some type of processing system is always at the heart of any computer system, whether the processing system includes one or several processors included in one or several devices. Thus, computer system 700 of FIG. 7 is presented as a simple example of a processing system. In the example of FIG. 7, computer system 700 comprises a processor 710 configured to control the operation of computer system 700, memory 704, storage 706, a network interface 708, a display output 712, a user interface 714, and a bus 702 configured to interface the various components comprising computer system 700.

Processor 710, in one embodiment, comprises a plurality of processing circuits, such as math coprocessor, network processors, digital signal processors, audio processors, etc. These various circuits can, depending on the embodiment, be included in a single device or multiple devices. Processor 710 also comprise an execution area into which instructions stored in memory 704 are loaded and executed by processor 710 in order to control the operation of computer system 700. Thus, for example, by executing instructions stored in memory 704, processor 710 causes credit derivative authority 102 to execute the steps described above.

Memory 704 comprises a main memory configured to store the instructions just referred to. In one embodiment, memory 704 also comprise secondary memory used to temporarily store instructions or to store information input into computer system 700, i.e., memory 704 acts as scratch memory also. Memory 704 can comprises, depending on the embodiment, a plurality of memory circuits, which can be included as a single device, or as a plurality of devices.

Storage 706 includes, in certain embodiments, a plurality of drives configured to receive various electronic media. For example, in one embodiment, storage 706 includes a floppy drive configured to receive a floppy disk, a compact disk drive configured to receive a compact disk, and/or a digital video disk drive configured to receive a digital video disk. IN another embodiment, storage 706 also includes disk drives, which can include removable disk drives. The drives included in storage 706 are used to receive electronic media that has stored thereon instructions to be loaded into memory 704 and used by processor 710 to control the operation of computer system 700.

Network interface 708 is configured to allow computer system 700 to interface with, and communicate over, network 106. Thus, using a network interface, such as network interface 708, credit derivative authority 102 is able to communicate with terminals 108. Depending on the embodiment, credit derivative authority 102 includes one or multiple network interfaces 708.

Display interface 712 can be configured to allow computer system 700 to interface with a display. Thus, in certain embodiments, computer system 700 displays information to a user via display interface 712.

User interface 714 is configured to allow a user to interface with computer system 700. Thus, depending on the embodiment, user interface 714 can include a mouse interface, a keyboard interface, an audio interface, etc.

It should be clear that the general description of a computer system provided above is by way of example only and should not be seen to limit implementation of credit derivative authority 102 to any particular computer architecture or implementation. Rather any architecture or implementation capable of implementing the processes and functionality described above can be used to implement the systems and methods described herein.

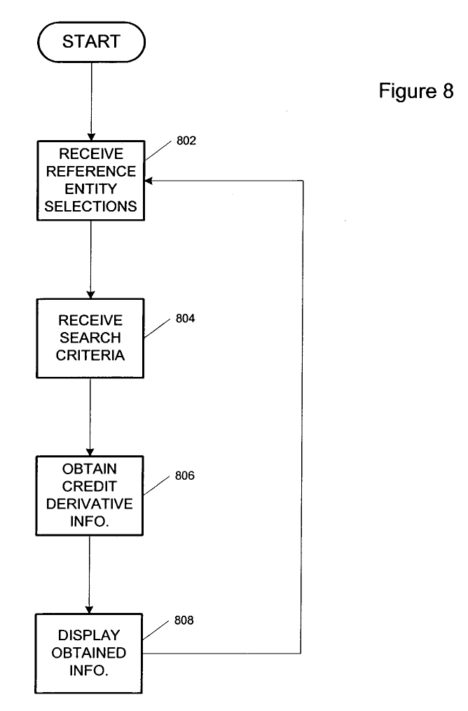

In certain embodiments credit derivative authority 102 can be configured to allow trader clients, using their trader client terminals 108, to select reference entities for which they would like to receive credit derivative information. FIG. 8 is a flow chart illustrating an example method whereby a trader client can select reference entities for which they would like to receive credit derivative information from credit derivative authority 102 in accordance with one embodiment of the systems and methods described herein. Thus, in step 802, credit derivative authority 102 receives reference entity selections from a trader client terminal 108. The reference entity selections received in step 802 define the reference entities for which credit derivative information is desired. In step 804, credit derivative authority 102 receives search criteria from the trader client, via that associated trader client terminal 108, defining what type of credit derivative information the trader client would like to receive. The types of credit derivative information that a trader client can receive are described in more detail below.

In step 806, credit derivative authority 102 obtains the desired credit derivative information from, e.g., database 104, based on the search criteria received in step 804. In step 808, credit derivative authority 102 then causes the information obtained in step 806 to be displayed on the associated trader client terminal 108. Once the information is displayed in step 808, the process can revert to step 802 wherein credit derivative authority 102 can receive new reference entity selections and or new search criteria in step 804.

The process described in the proceeding paragraph allows trader clients to individually obtain information on reference entities important to those trader clients. For example, a trader client, using the process described above, can search for credit derivative price histories for a single reference entity and, for example, review the chronology of last bid, offer and trade information for a specific day for the credit derivatives of the reference entity. A trader client can also obtain, using a process described above, the intra day price movements for the credit derivatives of a specific reference entity for any specific day. A trader client can also obtain the historical prices for the credit derivatives of a reference entity, which can be displayed can be displayed in graphical form. The trader client can, for example, use such information to track trends in the price of the credit derivatives associated with the reference entity. A trader client can also obtain the historical price for the credit derivatives associated with a reference entity, relative to other reference entities of the same credit rating and/or industry. This information can also be displayed in graphic form.

Further, a trader client can limit the scope of the information received by specifying in the search criteria provided to credit derivative authority a posted date, transaction size, debt level, i.e., senior or subordinate, bid, offer, trade, or any combination of the above.

Thus, for example, a trader client using their trader client terminal 108 supplies search criteria to credit derivative authority 102 specifying the type of credit derivative information they would like to receive. The search criteria will include a selection of reference entities for which the trader client would like credit derivative information (step 802). Then, the trader client will provide credit derivative authority 102 with the search criteria defining what type of credit derivative information the trader client would like to receive (step 804). The search criteria will also define the scope of the credit derivative information the trader client is interested in for each of the reference entities selected in step 802. Moreover, each trader client can specify custom search criteria and receive individualized credit derivative information based on their search criteria.

The process above allows a trader client to search for the credit derivative price history information for multiple reference entities. The multiple reference entities can be selected based on region, credit rating, industry, or any combination of the above. Thus, a trader client can obtain and compare price history information for various reference entities that are related based on some relevant criteria. The trader client can also define how the information is displayed on the trader client terminal 108. For example, by providing the appropriate search criteria, a trader client can request that the information displayed be in graphical form. For example, the trader client can, therefore, compare price history information for a plurality of reference entities versus time.

In another embodiment, rather than specify specific reference entities, a trader client simply indicates a desire to see the price history information for all reference entities stored in database 104, but indicates a desire to limit the view based on region, industry, and or credit rating, for example. Credit derivative authority 102 will then obtain the relevant credit derivative information and display it to the trader client. The trader client, in certain embodiments, further customizes their view of credit derivative information by specifying the credit derivative authority 102 only display price history information for credit derivative for which the price has either gone up or gone down during a specified period. In certain implementations, the trader client defines the period of interest. In other words, the relevant period for which price movement is being tracked and displayed to the trader client can be defined by the trader client through search criteria provided to credit derivative authority 102.

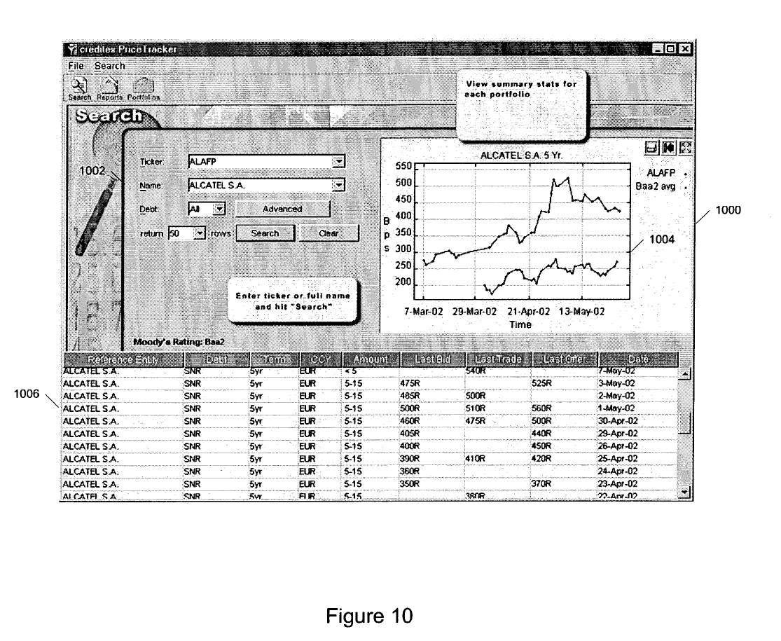

FIG. 10 is a screen shot illustrating an example display 1000 that is displayed on a trader client terminal 108 and allows a trader client to input search criteria and view credit derivative information. As can be seen, display 1000 includes a search area 1002 in which the trader client can input search criteria. The search criteria can include the ticker symbol for a reference entity of interest, the name of the reference entity, the type of debt the trader client is interested in, as well as other relevant search criteria. Credit derivative authority 102 will retrieve credit derivative information from database 104 based on the search criteria input in the search area 1002. The credit derivative information can then be displayed to the trader client in tabular form as illustrated by area 1006 of display 1000. Alternatively, the credit derivative information can be displayed in graphical form as illustrated by the graph 1004 in display 1000.

The ability to specify and obtain credit derivative information by reference entity allows trader clients to define portfolios of reference entities for which they would like credit derivative information to be tracked at the portfolio level. Thus, once a trader client has defined a portfolio, the trader client can view the most recent bid, offer, and trade information for the credit derivatives associated with each reference entity within the portfolio, including the date of the most recent price. The trader client can also view all prices, i.e., bid, offer, and trade information, for a specified period for the credit derivatives associated with each reference entity in the portfolio. The trader client can also see how each bid, offer, and trade has changed, i.e., amount of price movement and the date of the previous price for the credit derivatives associated with each reference entity included in the portfolio.

Further, the trader client can see the average movement for the whole portfolio, which can be graphed over the most recent relevant dates as defined by the trader client. In certain embodiments, the trader client can even export the portfolio data to other applications.

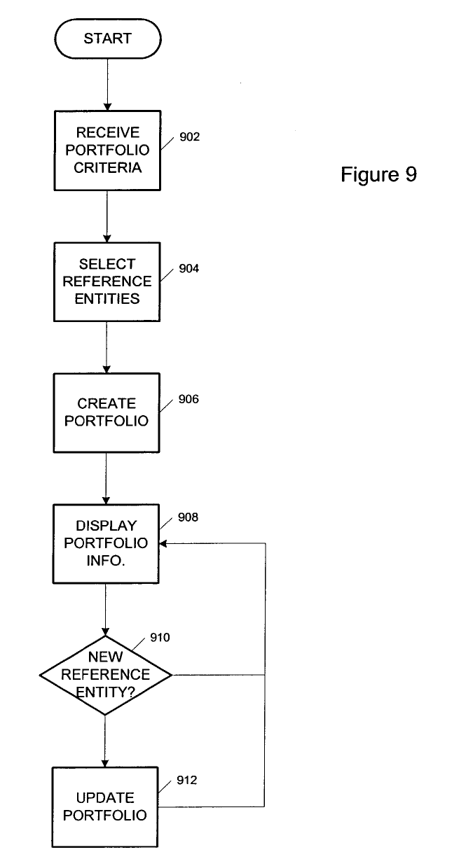

In another embodiment, trader clients can automatically create portfolios of reference entities by simply providing portfolio criteria to credit derivative authority 102. FIG. 9 is a flow chart illustrating a method whereby a trader client can provide portfolio criteria to create a portfolio in accordance with one embodiment of systems and methods described herein. Thus, in step 902, the trader client will provide through trader client terminal 108 the portfolio criteria, which will be received by credit derivative authority 102. For example, the portfolio criteria can include regions, industries, and or credit ratings that define the credit derivatives for relevant reference entities. In step 904, credit derivative authority 102 will select reference entities to include in the portfolio from database 104 based on the portfolio criteria provided in step 902. In one embodiment, credit derivative authority 102 is configured to select credit derivatives to include in the portfolio that maximize the average rating of the portfolio. In other words, credit derivative authority 102 can be configured to optimize the portfolio based on the user define criteria provided in step 902. The portfolio can be optimized based on other factors besides average rating. For example, the portfolio could be optimized for diversity alone, or in combination with being optimized for the average rating.

In step 906, credit derivative authority 102 will create the portfolio and display credit derivative information for each reference entity within the portfolio to the trader client in step 908. In certain embodiments, the trader client may select new reference entities to be included in the portfolio as illustrated by step 910. If new reference entities are selected in step 910, then in step 912 credit derivative authority 102 will update the portfolio based on the newly selected entities and display the updated information to the trader client.

In one embodiment, credit derivative authority is configured to continually search information in database 104 to find reference entities that will improve the overall optimization if included in the portfolio. The trader client is then given the opportunity to select (step 910) whether or no to include any such reference entities within the portfolio. In one embodiment, whenever a new reference entity is added to the portfolio, a reference entity is correspondingly dropped from the portfolio. Thus, selecting a new reference entity is step 910 can, depending on the embodiment, include selecting one reference entity to be included in the portfolio to the exclusion of another. In an alternative embodiment, step 910 simply comprises the trader client selecting a reference entity to be dropped from the portfolio without any corresponding reference entity being added to the portfolio.

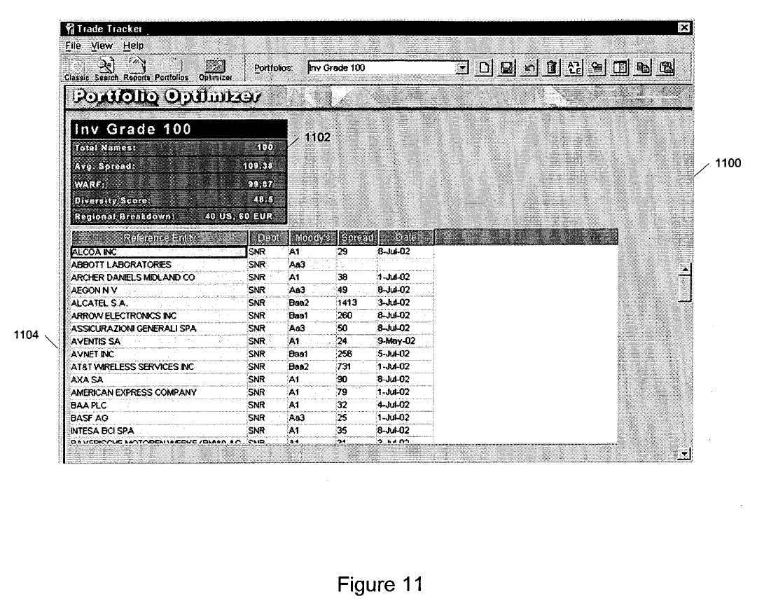

FIG. 11 illustrates a screen shot of an example display 1100 that provides a trader client with portfolio optimization information. Thus, display 1100 includes an area 1102 that displays to the trader client the name of the portfolio as well as certain optimization information. This optimization information can include the total number of reference entities included in the portfolio, the average spread for the credit derivatives of the reference entities in the portfolio, the diversity score, which is an attempt to indicate how diverse the portfolio is, as well as a regional break down of the reference entities included in the portfolio. Further, information for each individual reference entity is also displayed to the trader client in area 1104 in display 1100. Thus, the trader client can scroll through the reference entities included in the portfolio and view credit derivative information for each reference entity.

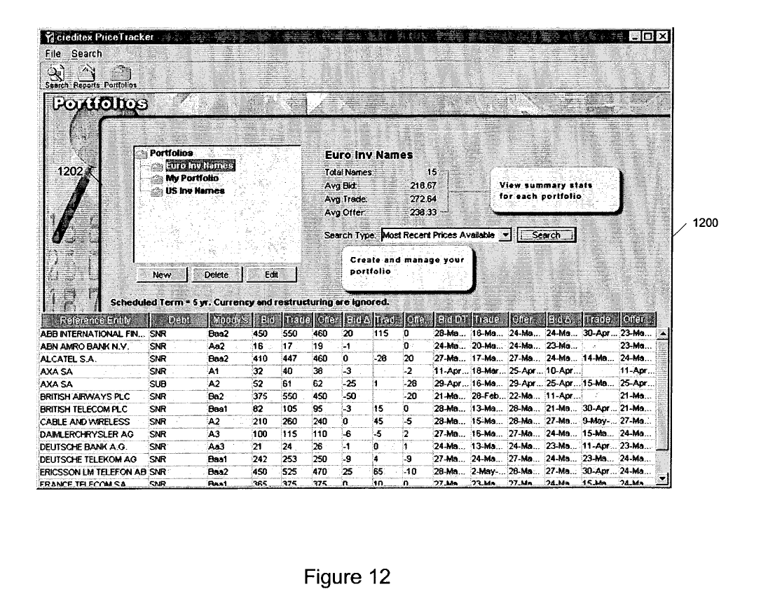

System 100 can also be configured to allow trader clients to manage information for a plurality of portfolios. FIG. 12, for example, illustrates a display 1200 that allows the trader client to navigate through a plurality of portfolios. Thus, display 1200 includes a portfolio navigation area 1202 that allows the trader client to select portfolios for which the trader client would like to view portfolio information. Portfolio navigation area 1202 is configured to display to the trader client information on a portfolio basis for the selected portfolio. Further, credit derivative information for each individual reference entity included in the selected portfolio is displayed in area 1204 of display 1200.

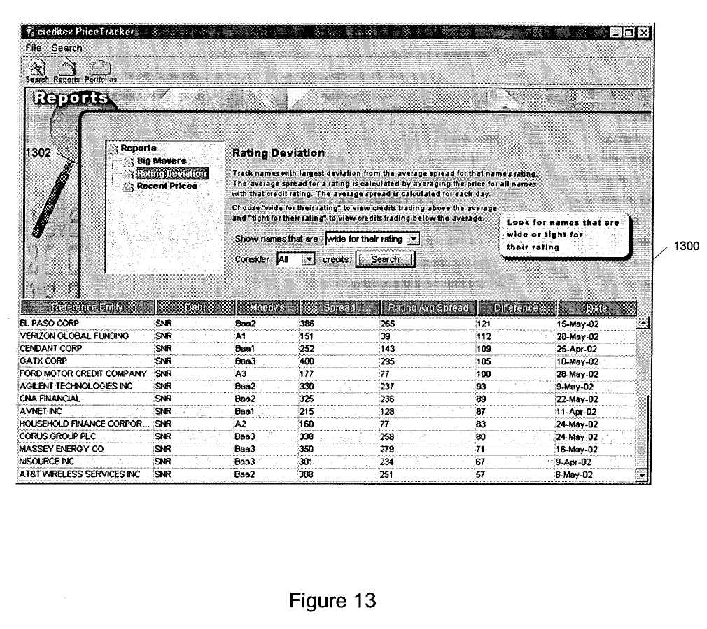

System 100 can also be configured to allow trader clients to select and generate various reports. FIG. 13 is a screen shot illustrating an example display 1300 that allows a trader client to navigate through, and select, available reports. Thus, display 1300 includes a report area 1302 in which a trader client can make selections of the reports that the trader client desires. Based on the selection, credit derivative authority 102 will obtain the necessary credit derivative information from database 104 and generate the selected report. The trader client can then view the report on their trader client terminal 108. In certain embodiments, the trader client can print out the report, forward the report, or export the report into another application. The reports can relate to individual, or selected reference entities or to a portfolio of reference entities.

It should be noted that the ability to specify and receive credit derivative information for one or more reference entities can be implemented whether or not the other functionality described herein is included in system 100. Similarly, the ability to define and track credit derivative information on a portfolio basis can also be implemented whether or not the other functionality described herein is included in system 100. Therefore, the example embodiments described above should not be seen as requiring particular combinations of functionality.

While certain embodiments of the inventions have been described above, it will be understood that the embodiments described are by way of example only. Accordingly, the inventions should not be limited based on the described embodiments. Rather, the scope of the inventions described herein should only be limited in light of the claims that follow when taken in conjunction with the above description and accompanying drawings.

What is claimed:

1. A credit derivative authority, comprising:
a database configured to store credit derivative information for a plurality of reference entities;
memory configured to store execution instructions; and
a processor coupled with the database and the memory, the processor configured to execute the instructions, the instructions configured to cause the processor to receive search criteria related to certain of the plurality of reference entities, obtain credit derivative information related to the certain reference entities from the database based on the search criteria, and cause the credit derivative information retrieved from the database to be displayed.

2. The credit derivative authority of claim 1, wherein the received search criteria include identification of the reference entities for which credit derivative information is to be obtained from the database.

3. The credit derivative authority of claim 1, wherein the received search criteria includes a request for chronological information related to at least one of bids, offers, or trades involving credit derivatives associated a reference entity, and wherein the instructions are further configured to cause the processor to retrieve the requested chronology information and cause the requested chronology information to be displayed.

4. The credit derivative authority of claim 3, wherein the requested chronology information includes a specification of the day or days for which the chronology information is requested.

5. The credit derivative authority of claim 1, wherein the received search criteria includes a request for intra-day price movement information for a credit derivative associated with a reference entity, and wherein the instructions are further configured to cause the processor to retrieve the requested intra-day price movement information and cause the requested intra-day price movement information to be displayed.

6. The credit derivative authority of claim 1, wherein the received search criteria includes a request for historical price information for a credit derivative associated with a reference entity, and wherein the instructions are further configured to cause the processor to retrieve the requested historical price information and cause the requested historical price information to be displayed.

7. The credit derivative authority of claim 6, wherein the received search criteria includes a request that the historical price information be displayed in graphic form, and wherein the instructions are further configured to cause the process to display the requested price information in graphic form.

8. The credit derivative authority of claim 6, wherein the received search criteria includes a request for historical price information for credit derivatives associated with a plurality of reference entities of the same credit rating or industry.

9. The credit derivative authority of claim 1, wherein the received search criteria includes a request to limit the retrieval of credit derivative information from the database based on at least one of a posted date, transaction information, a debt level, a bid, or an offer.

10. The credit derivative authority of claim 1, wherein the instructions are further configured to cause the processor to receive a selection of reference entities for which price history information is requested, and wherein the selection of the reference entities is based on at least one of a region, a credit rating, or an industry.

11. The credit derivative authority of claim 1, wherein the received search criteria includes a request to graph and compare price history information over time for the credit derivatives associated with a plurality of reference entities, reference entities within a certain industry, certain reference entities based on credit rating, or certain reference entities based on geographical region, or any combination of the above.

12. The credit derivative authority of claim 1, wherein the received search criteria includes a request for price information for credit derivatives associated with all reference entities for which price information is stored in the database.

13. The credit derivative authority of claim 12, wherein the received search criteria includes a request to limit the request for price information based on a geographical region, an industry or a credit rating.

14. The credit derivative authority of claim 1, wherein the received search criteria includes a specified period, and a request for credit derivative information for reference entities for which the price of the associated credit derivative has either gone up or gone down during the specified period.

15. A method for tracking credit derivative information, comprising:
receiving search criteria related to a plurality of reference entities;
obtaining credit derivative information related to the certain reference entities based on the search criteria; and
causing the credit derivative information retrieved from the database to be displayed.

16. The method of claim 15, further comprising receiving search criteria that includes identification of the reference entities for which credit derivative information is to be obtained from the database.

17. The method of claim 15, further comprising receiving search criteria that includes a request for chronological information related to at least one of bids, offers, or trades involving credit derivatives associated a reference entity, retrieving the requested chronology information, and displaying the requested chronology information.

18. The credit derivative authority of claim 17, wherein the request for chronology information includes a specification of the day or days for which the chronology information is requested.

19. The method of claim 15, further comprising receiving search criteria that includes a request for intra-day price movement information for a credit derivative associated with a reference entity, retrieving the requested intra-day price movement information, and displaying the requested intra-day price movement information.

20. The method of claim 15, further comprising receiving search criteria that includes a request for historical price information for a credit derivative associated with a reference entity, retrieving the requested historical price information, and displaying the requested historical price information.

21. The credit derivative authority of claim 20, further comprising receiving search criteria that includes a request that the historical price information be displayed in graphic form, and displaying the requested price information in graphic form.

22. The method of claim 20, further comprising receiving search criteria that includes a request for historical price information for credit derivatives associated with a plurality of reference entities of the same credit rating or industry.

23. The method of claim 15, further comprising receiving search criteria that includes a request to limit the retrieval of credit derivative information from the database based on at least one of a posted date, transaction information, a debt level, a bid, or an offer.

23. The method of claim 15, further comprising receiving a selection of reference entities for which price history information is requested, wherein the selection of the reference entities is based on at least one of a region, a credit rating, or an industry.

24. The method of claim 15, further comprising receiving search criteria that includes a request to graph and compare price history information over time for the credit derivatives associated with a plurality of reference entities, reference entities within a certain industry, certain reference entities based on credit rating, or certain reference entities based on geographical region.

25. The method of claim 15, further comprising receiving search criteria that includes a request for price information for credit derivatives associated with all reference entities for which price information is stored in a database.

26. The method of claim 25, further comprising receiving search criteria includes a request to limit the request for price information based on a geographical region, an industry or a credit rating.

27. The method of claim 15, further comprising receiving search criteria that includes a specified period, and a request for credit derivative information for reference entities for which the price of the associated credit derivative has either gone up or gone down during the specified period.

28. A method for optimizing the view of certain credit derivative information, comprising:
receiving portfolio criteria from a trader client;
selecting certain reference entities based on the received criteria;
creating a portfolio of reference entities that includes the selected reference entities; and
causing credit derivative information to be displayed to the trader client for the created portfolio.

29. The method of claim 28, wherein the displayed information includes the average rating or price information for credit derivatives associated with each of the reference entities in the portfolio.

30. The method of claim 29, wherein the displayed information includes the distribution of credit derivatives by industry, geographical region, or credit rating for each of the reference entities in the portfolio.

31. The method of claim 28, further comprising receiving a selection of at least one new reference entity to be included in the portfolio, and updating the information in the portfolio to include credit derivative information for the newly selected reference entity.

32. The method of claim 28, further comprising receiving a selection of a reference entity included in the portfolio to be removed from the portfolio, and removing the selected reference entity from the portfolio.

33. The method of claim 28, further comprising receiving a request for a report, obtaining credit derivative information for certain reference entities from the database based on the requested report and displaying the credit derivative information to the trader client in a format based on the requested report.

34. A credit derivative authority, comprising:
a database configured to store credit derivative information for a plurality of reference entities;
memory configured to store execution instructions; and
a processor coupled with the database and the memory, the processor configured to execute the instructions, the instructions configured to cause the processor to receive portfolio criteria from a trader client, select certain reference entities based on the received criteria, create a portfolio of reference entities that includes the selected reference entities, and cause credit derivative information to be displayed to the trader client for the created portfolio.

35. The credit derivative authority of claim 34, wherein the instructions are further configured to cause the processor to display credit derivative information that includes the average rating or price information for credit derivatives associated with each of the reference entities in the portfolio.

36. The credit derivative authority of claim 35 wherein the instructions are further configured to cause the processor to display credit derivative information that includes the distribution of credit derivatives by industry, geographical region, or credit rating for each of the reference entities in the portfolio.

37. The credit derivative authority of claim 34, wherein the instructions are further configured to cause the processor to receive a selection of at least one new reference entity to be included in the portfolio, and updating the information in the portfolio to include credit derivative information for the newly selected reference entity.

38. The credit derivative authority of claim 34, wherein the instructions are further configured to cause the processor to receive a selection of a reference entity included in the portfolio to be removed from the portfolio, and removing the selected reference entity from the portfolio.

39. The credit derivative authority of claim 34, wherein the instructions are further configured to cause the processor to receive a request for a report, obtain credit derivative information for certain reference entities from the database based on the requested report, and display the credit derivative information to the trader client in a format based on the requested report.
